(19) United States
(12) Patent Application Publication
(10) Pub. No.: US 2025/0208249 A1
(43) Pub. Date: Jun. 26, 2025

(54) Method for locating a GNSS jamming source, and associated computer program product and locating device

(71) Applicant: THALES, Meudon (FR)

(72) Inventors: Nicolas MARTIN, VALENCE CEDEX (FR); Olivier DEVELLE, VALENCE CEDEX (FR); Nicolas FOURNY, VALENCE CEDEX (FR)

(21) Appl. No.: 18/848,519

(22) PCT Filed: Mar. 24, 2023
(86) PCT No.: PCT/EP2023/057593

§ 371 Date: Sep. 19, 2024

(30) Foreign Application Priority Data
Mar. 25, 2022 (FR) FR2202680

(51) Int. Cl. G01S 3/48; G01S 3/04; G01S 19/21

(52) U.S. Cl. CPC G01S 3/48; G01S 3/043; G01S 19/21

(57) ABSTRACT

A method for locating a GNSS signal-jamming source, including setting two antennas in rotation about a common axis of rotation so as to form N different respective positions corresponding to various angles of rotation, in each of the N positions, using each antenna to acquire a GNSS signal including a payload signal and a jamming signal, computing a phase offset between the acquired jamming signals, and determining a direction of the jamming source using a maximum value of the N computed phase shifts.

### CROSS-REFERENCE TO RELATED APPLICATIONS

This application claims benefit under 35 USC § 371 of PCT Application No. PCT/EP2023/057593 entitled METHOD FOR LOCATING A GNSS JAMMING SOURCE, AND ASSOCIATED COMPUTER PROGRAM PRODUCT AND LOCATING DEVICE, filed on Mar. 24, 2023 by inventors Nicolas Martin, Olivier Develle and Nicolas Fourny. PCT Application No. PCT/EP2023/057593 claims priority of French Patent Application No. 22 02680, filed on Mar. 25, 2022.

### FIELD OF THE INVENTION

The present invention relates to a method for locating a GNSS jamming source (standing for “Global Navigation Satellite Systems”).

The present invention further relates to a computer product program and a locating device related to the method.

More particularly, the technical field of the invention is the field of devices for locating GNSS jamming sources based on antenna arrays. The purpose of such devices is to accurately and quickly determine the position of the jamming source in order to put an end to jamming by appropriate means.

### BACKGROUND OF THE INVENTION

In the prior art, there are already many methods for determining the direction of arrival of radio-electric signals, including GNSS signals.

Such known methods include e.g. the technique implemented by the so-called ARVA (Appareil de Recherche de Victimes d'Avalanche [search apparatus for avalanche victims]) devices which are used in the mountains to find avalanche victims. An ARVA device activated in reception mode roughly indicates the direction of arrival of the signal transmitted by a corresponding beacon of the victim. Thereof allows a spared person to quickly find the victim's position under the snow.

As regards the determination of the direction of arrival of jamming signals during GNSS navigation, methods using antenna arrays are known. The methods are generally based on the phase shifts between the signals received on the different antennas to find the directions of arrival of the jamming signals. The devices implementing such methods are generally stationary and require the use of a plurality of beacons to find the position of the jamming source by crossing angular sectors, with the removal of ambiguity.

The precise location of the position of the GNSS signal jamming source with stationary beacons, however, requires a high accuracy of angular measurements because of the distance between the beacons. Approaching the beacons generally improves the accuracy of location but also reduces the area covered. It is possible to increase the number of beacons but thereof raises problems related to the cost of installation and of maintenance.

### SUMMARY OF THE DESCRIPTION

The goal of the present invention is to remedy such drawbacks and to propose a way of locating the GNSS signal jamming source that does not require a stationary beacon, while remaining relatively precise. Same reduces the cost of installation and maintenance.

To this end, the subject matter of the invention relates to a method of locating a GNSS jamming source comprising the following steps:
rotating two antennas about a common axis of rotation so as to form N different respective positions corresponding to different angles of rotation;
in each of the N positions, acquisition by each antenna of a GNSS signal comprising a payload signal and a jamming signal, and computation of a phase shift between the jamming signals acquired;
determination of a direction of the jamming source using a maximum value of the N calculated phase shifts.

Due to such characteristics, the method according to the invention avoids the use of stationary beacons while remaining precise. Indeed, the phase shift measured between the two rotating antennas as a function of the angle of rotation describes a curve, the maximum of which indicates the angle of rotation for which the two antennas are aligned along the direction of the jamming source. without the ambiguity about the two opposite directions. The invention thus proposes to use the maximum to determine the direction of the jamming source.

According to other advantageous aspects of the invention, the method comprises one or a plurality of the following features, taken individually or according to all technically possible combinations:
the rotation of the two antennas is performed by a rotating carrier, the antennas being advantageously stationary with respect to the carrier;
the rotation of the antennas comprises a full turn;
the GNSS signal acquired in each position comprises K samples of the signal;
the computation of each phase shift between the acquired jamming signals comprises the computation of a complex coefficient of cross-correlation between the samples of the GNSS signals acquired in the corresponding position;
the computation of each phase shift between the jamming signals acquired is determined by the argument of the complex cross-correlation coefficient;
the determination of the direction of the jamming source comprises the determination of an azimuth angle of the jamming source in a local coordinate frame associated with the two antennas, the azimuth angle being determined in a plane of rotation of the two antennas;
the azimuth angle is determined as the angle of rotation of the antennas in the respective position of the antennas corresponding to the maximum value of the N computed phase shifts;
a step of determining a direction of the jamming source in a geographical coordinate frame from said azimuth angle of the jamming source and inertial data characterizing an angular position of the antennas in the geographical coordinate frame;
the direction of the jamming source is specified by repeating said steps of the method from a different geographical position of the antennas;
said different geographical position is determined along the direction of the jamming source determined during an iteration preceding said steps of the method.

A further subject matter of the invention relates to a product computer program including software instructions which, when executed by a computer, implement a method as described hereinabove.

A further subject matter of the invention relates to a device for locating a jamming source, comprising technical means suitable for implementing the method as defined hereinabove.

### BRIEF DESCRIPTION OF THE DRAWINGS

The features and advantages of the invention will appear upon reading the following description, given only as an example, but not limited to, and making reference to the enclosed drawings, wherein:

FIG. 1 is a schematic view of a device for locating a jamming source according to the invention;

FIG. 2 is a flowchart of a detection method according to the invention, the method being implemented by the device shown in FIG. 1; and

FIGS. 3 and 4 are views illustrating the implementation of at least certain steps of the locating method shown in FIG. 2.

### DETAILED DESCRIPTION OF EMBODIMENTS

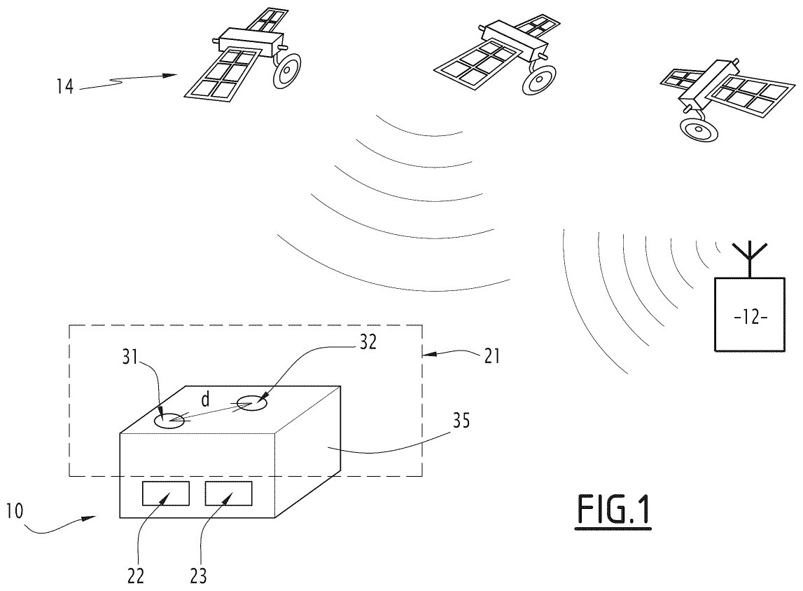

FIG. 1 illustrates a device 10 for locating a GNSS signal jamming source 12.

The jamming source 12 has e.g. any electronic device serving to transmit radio signals, called jamming signals, preventing normal reception, by a GNSS receiver, of GNSS signals coming from a GNSS system 14. More particularly, as is known per se, the GNSS system 14 is formed by a plurality of satellites configured to transmit GNSS signals to the ground. The GNSS receiver receives the signals from at least certain of the satellites of the GNSS 14 system in order to determine the geographical position thereof. The GNSS 14 system is e.g. the GPS (Global Positioning System) system or the GALILEO system, known per se.

In one embodiment, the jamming source 12 is intended to deliberately impair the proper operation of the GNSS receiver. In another embodiment, the jamming source 12 unintentionally impairs the proper operation of the GNSS receiver.

The locating device 10 according to the invention serves to localize the jamming source 12. Once localized, the jamming source 12 can be deactivated to re-establish the proper operation of the GNSS receiver.

With reference to FIG. 1, the locating device 10 comprises an input module 21, a processing module 22 and an output module 23. In certain cases, the locating device 10 further comprises a GNSS receiver serving to determine the position thereof in the absence of jamming signals.

The input module 21 serves to receive radio signals, in particular GNSS signals, which comprise payload signals coming from the GNSS system 14 and jamming signals coming from the jamming source 12. The input module 21 also serves to transmit the received signals to the processing module 22.

To receive GNSS signals, the input module 21 comprises an antenna array comprising at least two antennas spaced apart from each other. In the example shown in FIG. 1, two antennas 31 and 32 are illustrated. In a generic case, the antenna array may comprise a number of antennas strictly greater than 2.

As shown in FIG. 1, the antennas 31, 32 are arranged on a carrier 35 in the same plane and are spaced apart from each other in the plane by a distance d. The carrier 35 is advantageously an aircraft, in particular a drone.

According to the preferred embodiment of the invention, the antennas 31, 32 are stationary with respect to the carrier 35. In such a case, the carrier 35 has a rotating carrier apt to rotate the plane comprising the antennas 31, 32 about an axis of rotation perpendicular to the plane.

According to another embodiment, the antennas 31, 32 are mounted on a rotating platform which is apt to rotate with respect to the carrier 35. In such a case, the carrier 35 is configured to move in space along e.g. a substantially rectilinear trajectory or has a stationary carrier.

The processing module 22 is configured to process the GNSS signals received by the input module 21 in order to determine the direction of the jamming source 12, as will be explained in greater detail thereafter.

The processing module 22 takes the form e.g. of one or a plurality of software stored in a memory and executable by one or a plurality of processors. In a variant or in addition, the processing module 22 is at least partially in the form of a programmable logic circuit, such as an FPGA (Field-Programmable Gate Array) circuit.

In certain embodiments, the processing module 22 is further configured to control the operation of the antennas 31, 32 and, if appropriate, of the carrier 35. For example, the processing module 22 is configured to control the rotation of the antennas 31, 32 as explained hereinabove. According to other embodiments, the control of the carrier 35 and in particular the setting in rotation of the antennas 31, 32 are carried out from a dedicated control module embedded in the carrier 35 or remote therefrom. Such a control module may also be a part of the locating device 10.

In the example shown in FIG. 1, the processing module 22 is embedded in the carrier 35, just like the input module 21. According to another embodiment, the processing module 22 is offset from the carrier 35. In such a case, same is apt to receive the signals received by the input module 21 by any appropriate means.

The output module 23 is configured for delivering the processing performed by the processing module 22. More particularly, the output module 23 is configured for delivering the direction of by the jamming source 12 determined by the processing module 22. For example, the direction of the jamming source 12 is delivered in the form of a heading angle of the jamming source 12 in a geographical coordinate frame the axes of which are e.g. formed by the North, East and vertical directions. According to another embodiment, the direction of the jamming source 12 is delivered in the form of an angle between the direction of movement of the carrier 35 and the direction of the jamming source 12. In the first case, thereof is thus an absolute direction of the jamming source 12 and in the second case, a relative direction.

The output module 23 is e.g. suitable for supplying the absolute and/or relative direction of the jamming source 12 to an operator and/or to any other system that can be used e.g. to control the carrier 35, such as the control module mentioned hereinabove.

Finally, just like the processing module 22, the output module 23 can be carried on board the carrier 35 or then offset therefrom.

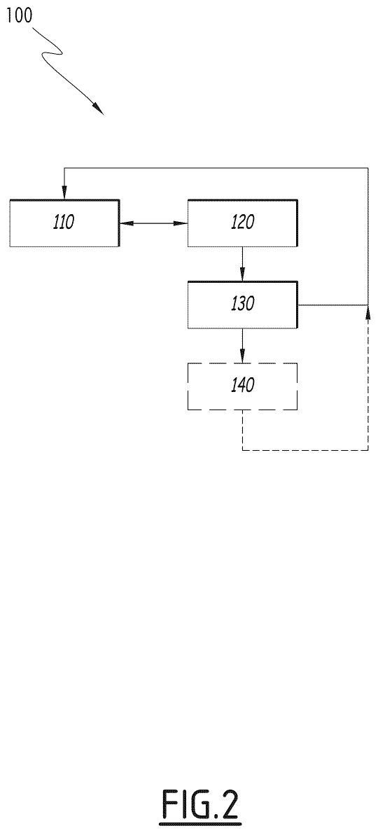

The locating device 10 serves to implement the method of locating 100 according to the invention, which will henceforth be explained with reference to FIG. 2 which shows a flowchart of the steps thereof.

During an initial step 110, the antennas 31, 32 are rotated about the axis of rotation to form N different respective positions corresponding to different angles of rotation.

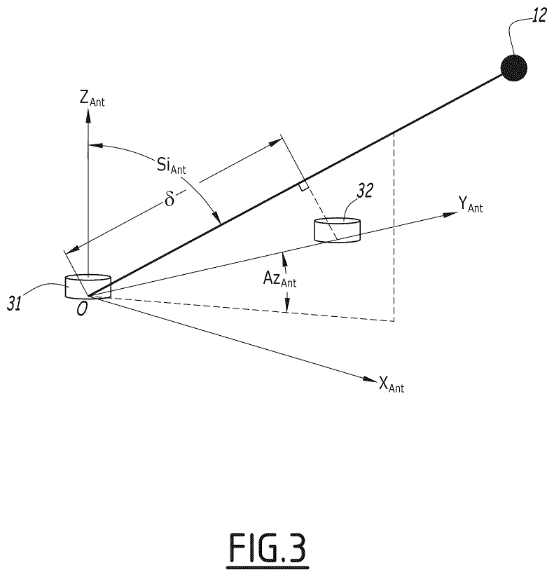

More particularly, in the example of FIG. 3 illustrating a coordinate frame (X_{Ant}, Y_{Ant}, Z_{Ant}) linked to the array of antennas, the antenna 31 is placed at the center of the coordinate frame and the antenna 32 is initially placed at a distance d from the antenna 32 along the axis OY_{Ant}. The plane (X_{Ant}, Y_{Ant}) thereby corresponds to the plane of rotation of the antennas 31, 32 and the axis OZ_{Ant} corresponds to the axis of rotation of the antennas 31, 32.

Advantageously, during the step 110, a complete revolution is performed about the axis OZ_{Ant}.

In each respective position of the antennas 31, 32 during the rotation thereof, the line connecting the centers of the two antennas forms an angle θ_{Ant} with respect to the axis OY_{Ant}. The angle θ_{Ant} thus defines each respective position of the antennas 31, 32 during the rotation thereof, called the angle of rotation. Given the initial position of the antenna 32, the angle θ_{Ant} varies from 0° to 360° during a full revolution.

The following step 120 is implemented in parallel with step 110.

During the step 120, in each position, each antenna 31, 32 acquires a GNSS signal comprising, as explained hereinabove, a payload signal and a jamming signal.

More particularly, each GNSS signal is acquired in the form of K samples.

Thereby, by noting s₁(k) the sample k acquired by the antenna 31 and s₂(k) the sample k acquired by antenna 32 in a given position, the samples can be written in the following form:

$$\begin{matrix}{s}_{1} ( k ) = {s}_{1 , GNSS} ( k ) + {s}_{1 , B} ( k ) \\ {s}_{2} ( k ) = {s}_{2 , GNSS} ( k ) + {s}_{2 , B} ( k )\end{matrix} \} , \qquad k = 1 .. K$$

where S_{p,GNSS}(k) refers to the payload signal and S_{p,B}(k) to the jamming signal of the sample k from the corresponding antenna p (p=1, 2).

During the same step, the processing module 22 then determines a phase shift Δφₑₛₜ between the jamming signals acquired in the corresponding position.

To this end, the processing module 22 first calculates the complex cross-correlation coefficient Rₓₓ of the acquired samples, according to the following expression:

$${R}_{xx} ( {s}_{1} , {s}_{2} ) = \frac{1}{K} {\sum }_{k = 1}^{K} {s}_{1} ( k ) \cdot {s}_{2}^{*} ( k )$$

where (.) * is the operator of complex conjugation.

The cross-correlation coefficient Rₓₓ is a complex number, i.e. a number with a real part Re(Rₓₓ) and an imaginary part Im(Rₓₓ).

The phase shift Δφₑₛₜ between the two jamming signals received on the two antennas is then given by the angle (or argument) of the complex number Rₓₓ, i.e.:

Δφₑₛₜ=atan 2(Im(Rₓₓ),Re(Rₓₓ)).

It is thus clear that during the step 120, a phase shift value Δφₑₛₜ is calculated for each of the N positions defined by the angle of rotation θ_{Ant}.

During the next step 130, the processing module 22 determines the relative direction of the jamming source 12 by using a maximum value of the N calculated phase shifts Δφₑₛₜ

More particularly, during the step 130, the processing module 22 determines an azimuth angle AZ_{Ant} of the jamming source 12 in the plane (X_{Ant}, Y_{Ant}). According to the invention, the azimuth angle corresponds to the maximum value of all the phase shifts Δφₑₛₜ between the two jamming signals determined during the preceding step.

More particularly, it is clear that the phase difference Δφₑₛₜ between the two jamming signals received by the two antennas 31, 32 is related to the azimuth Az_{Ant} and to the site of Si_{Ant} the jamming source 12 by the following relation:

$${Δφ}_{est} = \frac{2 π}{λ} δ + {b}_{φ}$$

where δ corresponds to the path difference between the antenna 32 and the antenna 31 as shown in FIG. 3, according to which:

$$δ = d \cdot cos ( {Az}_{Ant} - {θ}_{Ant} ) \cdot sin ( {Si}_{Ant} )$$

and where λ corresponds to the wavelength of the jamming signal, b_{φ} to a phase shift due to the defect of the antennas and analog channels of the electronic components, and Si_{Ant} is an elevation angle calculated with respect to the axis OZ_{Ant}.

The phase shift Δφₑₛₜ is thus written as:

$${Δφ}_{est} = \frac{2 π}{λ} d \cdot cos ( {Az}_{Ant} - {θ}_{Ant} ) \cdot sin ( {Si}_{Ant} ) + {b}_{φ}$$

Since the elevation angle Si_{Ant} remains constant during the rotation of the antennas, the last relation can be written as:

$${Δφ}_{est} ≅ C \cdot cos ( {Az}_{Ant} - {θ}_{Ant} ) + {b}_{φ} ,$$

where C is a constant value.

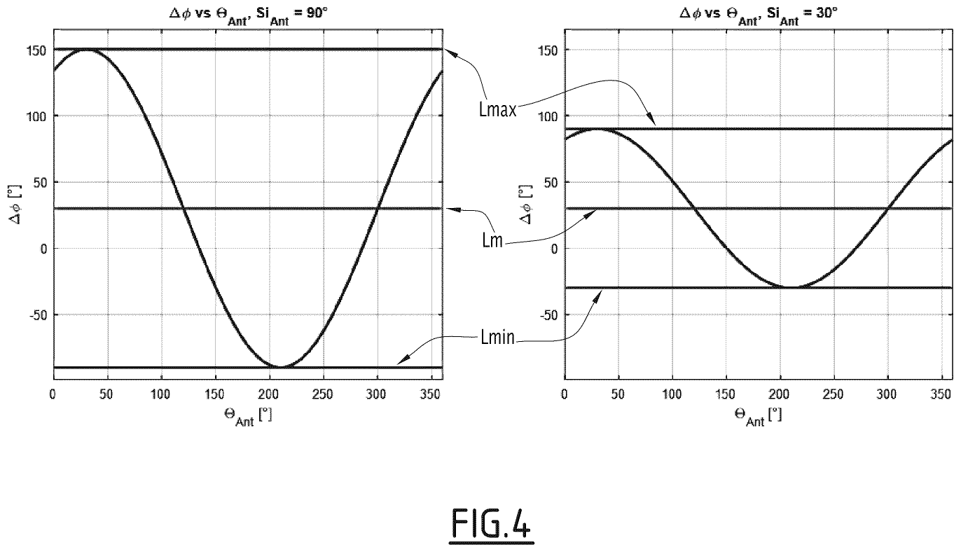

In other words, the phase shift Δφₑₛₜ has a sinusoidal curve. An example of curves Δφₑₛₜ is shown in FIG. 4. In particular, the FIG. 4 shows in the left-hand part thereof a sinusoidal curve of Δφₑₛₜ for the elevation value Si_{Ant}=90° and in the right-hand part thereof a sinusoidal curve of Δφₑₛₜ for the elevation value Si_{Ant}=30°. In both cases, it is considered that d=⅓ and b_{φ}=30°.

As the two examples show, it is clear that the phase shift Δφₑₛₜ reaches the maximum value thereof when Az_{Ant}=θ_{Ant}.

Thereby, during the step 130, the processing module 22 analyzes all the pairs {θ_{Ant}(k), Δφₑₛₜ(k)}_{k=1 . . . N, (θ}_{_{Ant}}_{(N)-θ}_{_{Ant}}_{(1))≥2π} obtained during the rotation during the previous step and obtains the arrival azimuth estimated Az_{Ant}^{est} by:

$$\{ \begin{matrix}{Az}_{Ant}^{est} = θ ( m ) \\ m = {arg max}_{k} ( {\{ {Δφ}_{est} ( k ) \}}_{k = 1 .. N , ( {θ}_{Ant} ( N ) - {θ}_{Ant} ( 1 ) ) \geq 2 π} )\end{matrix} .$$

In order to improve the accuracy of the determination of the index m of the position of the maximum of the function, in certain embodiments, the processing module 22 determines the intersections of the function Δφₑₛₜ with a median value (straight line Lm in FIG. 4) which is halfway between the maximum (straight line Lmax in FIG. 4) and the minimum (straight line Lmin in FIG. 4). The processing module 22 then determines the maximum of the function Δφₑₛₜ which is located at the center of the obtained two intersections framing the first estimated position of the maximum.

During the next step 140, if need be, the processing module 22 determines the direction of the jamming source 12 in the geographical coordinate frame.

To this end, the processing module 140 uses e.g. inertial data characterizing the angular position of the carrier 35 with respect to the geographical coordinate frame.

For example, the processing module 140 can associate an angular position of the carrier 35 with each phase shift value Δφₑₛₜ measured during the step 120 and can then determine the angular position of the carrier 35 corresponding to the maximum value of the phase shifts Δφₑₛₜ.

The direction of the jamming source 12 in the geographical coordinate frame (such as a heading) can then be obtained by transforming, in the geographical coordinate frame, the azimuth and elevation angles Az_{Ant} Si_{Ant} determined during the preceding step.

In the preferred embodiment of the invention, at least steps 110 to 130 and advantageously step 140 are repeated to specify the direction of the jamming source 12.

For example, steps 110 to 140 can be reiterated several times from different positions of the carrier 35 and then the direction of jamming source 12 is specified by cross-checking the results obtained during the different iterations.

According to another embodiment, only steps 110 to 130 are reiterated several times. In such case, for each subsequent iteration, the carrier 35 is directed along the direction of the jamming source 12 obtained during the preceding iteration. It is thus clear that in such case, only the relative direction of the jamming source 12 with respect to the carrier 35 is needed. The advantage of such solution is that even if the results of the first iterations are approximate, the carrier 35 will always end up converging in the right direction and the closer the carrier is, the more accurate the results will be.

1. A locating method of a GNSS signal jamming source, comprising:
setting in rotation two antennas about a common axis of rotation to form N different respective positions corresponding to different angles of rotation;
in each of the N positions,
acquiring by each antenna a GNSS signal comprising a useful signal and a jamming signal; and
computing a phase shift between the jamming signals acquired; and
determining a direction of the jamming source using a maximum value of the N calculated phase shifts.

2. The method according to claim 1, wherein said setting in rotation is performed by a rotating carrier, the antennas being stationary with respect to the carrier.

3. The method according to claim 1, wherein said setting in rotation comprises setting the two antennas in a full turn.

4. The method according to claim 1, wherein the GNSS signal acquired at each location comprises K samples of the signal.

5. The method according to claim 4, wherein said computing comprises calculating a complex coefficient of cross-correlation between the samples of the acquired GNSS signals at the corresponding position.

6. The method according to claim 5, wherein said computing comprises determining each phase shift between the acquired jamming signals by the argument of the complex cross-correlation coefficient.

7. The method according to claim 1, wherein said determining comprises determining an azimuth angle of the jamming source in a local coordinate frame associated with the two antennas, the azimuth angle being determined in a plane of rotation of the two antennas.

8. The method according to claim 7, wherein the azimuth angle is determined as the angle of rotation of the antennas in the respective position of the antennas corresponding to the maximum value of the calculated N phase shifts.

9. The method according to claim 7, further comprising determining a direction of the jamming source in a geographic coordinate frame, from the azimuth angle of the jamming source and inertial data characterizing an angular position of the antennas in the geographic coordinate frame.

10. The method according to claim 1, wherein the direction of the jamming source is specified by reiterating the method from a different geographical position of the antennas.

11. The method according to claim 10, wherein the different geographic position is determined along the direction of the jamming source determined in a preceding iteration of the method.

12. A computer program product including software instructions which, when executed by a computer, implement a a locating method of a GNSS signal jamming source, comprising:
setting in rotation two antennas about a common axis of rotation to form N different respective positions corresponding to different angles of rotation;
in each of the N positions,
acquiring by each antenna a GNSS signal comprising a useful signal and a jamming signal; and
computing a phase shift between the jamming signals acquired; and
determining a direction of the jamming source using a maximum value of the N calculated phase shifts.

13. A device for locating a jamming source for GNSS signals, comprising apparatus suitable for implementing a locating method of a GNSS signal jamming source, comprising:
setting in rotation two antennas about a common axis of rotation to form N different respective positions corresponding to different angles of rotation;
in each of the N positions,
acquiring by each antenna a GNSS signal comprising a useful signal and a jamming signal; and
computing a phase shift between the jamming signals acquired; and
determining a direction of the jamming source using a maximum value of the N calculated phase shifts.
